(19) United States
(12) Patent Application Publication
(10) Pub. No.: US 2009/0323885 A1
(43) Pub. Date: Dec. 31, 2009

(54) Devices, Systems, and Methods Comprising Graphite Having an Enhanced Neutron Diffusion Coefficient for Enhancing Power Reactor Performance

(76) Inventor: Charles D. BOWMAN, Los Alamos, NM (US)

Correspondence Address: LATIMER & MAYBERRY IP LAW, LLP, 13873 PARK CENTER ROAD, SUITE 106, HERNDON, VA, 20171, US

(21) Appl. No.: 12/466,502

(22) Filed: May 15, 2009

Related U.S. Application Data
(60) Provisional application No. 61/053,747, filed on May 16, 2008.

(51) Int. Cl. G21C 3/42

(52) U.S. Cl. 376/308

(57) ABSTRACT

The present invention relates to the field of energy generation. More particularly, the present invention relates to devices, systems, and methods for use in generating energy with graphite-moderated nuclear reactors. Embodiments of the invention include devices, systems, and methods for use in generating power that use graphite having a neutron diffusion coefficient higher than that of Acheson graphite. Specifically included embodiments comprise providing artificial graphite manufactured under high pressure during the graphitization process to cause a larger neutron diffusion coefficient than graphite not produced under pressure (Acheson graphite). Suitable graphite according to the invention includes graphite prepared under high pressure during the graphitization phase of the manufacturing process, which produces graphite with an increased diffusion coefficient by reducing the microcrystal diffraction scattering and increasing the non-diffractive (inelastic) scattering of the graphite.

### CROSS-REFERENCE TO RELATED APPLICATIONS

This application relies on the disclosure and claims the benefit of the filing date of U.S. Provisional Patent Application No. 61/053,747 filed May 16, 2008, the disclosure of which is hereby incorporated by reference in its entirety.

### BACKGROUND OF THE INVENTION

1. Field of the Invention

The present invention relates to the field of energy generation. More particularly, the present invention relates to devices, systems, and methods for use in generating energy with graphite-moderated nuclear reactors. Embodiments of the invention include devices, systems, and methods for use in generating power that use graphite having a neutron diffusion coefficient higher than that of Acheson graphite.

2. Description of the Related Art

The original reactors were heterogeneous graphite-moderated reactors using graphite produced by the Acheson process and natural uranium fuel. The three steps of the Acheson process are: (1) extrusion of a hydrocarbon paste embedded with coke graphitic particles to produce a structurally stable but low strength ingot, (2) the heating of this ingot to about 800° C. for a sufficient period to drive out all hydrogen, oxygen, and nitrogen to produce a pure carbon ingot, and (3) the final heating of this ingot to about 3000° C. to cause the carbon to crystallize around the coke particles to produce an ingot of artificial graphite consisting of microparticles of graphite interacting together to give the ingot sufficient structural strength for use in practical construction. The performance of these reactors as electric power sources was later improved by the use of enriched uranium instead of natural uranium. However, such reactors were steadily displaced by today's light-water-moderated reactors (LWRs) using enriched uranium.

After the LWR technology was well emplaced, there was an attempt to reintroduce graphite reactors as High Temperature He-Gas Cooled Reactors (HTGRs) that used enriched uranium fuel in essentially a homogeneous fuel configuration rather than the original heterogeneous approach. This technology failed apparently because the advantages it offered over the established LWR technology were not sufficient to justify their introduction. The HTGR might see a rebirth as a source of production of hydrogen for transportation fuel because it is able to produce the high quality heat (about 800° C.) necessary for efficient hydrogen production. However it still will carry the burdens of proliferation, near-term geologic storage, and reprocessing.

The key problem for all of today's reactor designs operating or envisaged is that too few neutrons are emitted in fission. If only 10% more than the 2.45 neutrons per fission of ²³⁵U (uranium-235) were emitted, far more of the natural uranium could be consumed as fuel in the original-type graphite reactors, the reactors could produce more fissile material than consumed, and the higher actinides and long lived fission products could be easily transmuted to stable species. The straightforward solution to the lack of neutrons was to use enriched uranium as fuel that could be readily made by enrichment technology developed for nuclear weapons programs. The lack of sufficient neutrons also could be overcome, and more fuel burned, by separating out the fission products and higher actinides that consume neutrons, mostly unproductively, using the reprocessing technology developed for plutonium production for nuclear weapons. The fissile plutonium generated from neutron capture in ²³⁸U (uranium-238) could be subsequently used as fuel. The insufficiency of fission neutrons therefore led directly to all of nuclear power's present problems and the present extremely burdensome coupling of civilian power reactor technology with weapons technology.

These difficulties could be avoided if more neutrons were available. Nuclear power technology took the path it did because fifty years ago there were no known practical means to provide more neutrons. That is no longer true when two practical methods exist and this patent introduces a third.

Of the known means for producing more neutrons, the first is supplementing the fission neutrons with accelerator-produced neutrons. This involves using a small fraction of the electric power to drive a proton accelerator in the 1000-MeV range with the proton beam producing neutrons when it strikes a heavy metal target located inside the reactor. Several patents exist from the 1990's era (e.g., U.S. Pat. No. 5,160,696, to Bowman, the entirety of which is hereby incorporated by reference) describing various means for supplementing the neutron economy in this way. With today's accelerator technology, it is practical to boost the neutron economy by 1-5%.

The second is to eliminate the loss of neutrons to control rods by appropriate use of liquid fuel. The concept described in U.S. Pat. No. 6,233,298, to Bowman, the entirety of which is hereby incorporated by reference, is that of a large bucket containing graphite rods and liquid nuclear fuel in the form of molten salt. The bucket has an overflow spout and is full so that when fresh fuel is added in small amounts, such as a liter per hour, a liter per hour overflows out of the bucket that might contain about 25,000 liters. For this example the average atom of input fuel stays in the bucket for about three years. During this time the incoming fuel if it is uranium may undergo fission producing fission product waste, or it may capture neutrons to produce heavier atoms including plutonium. Obviously the material coming out is different from that fed in, but if the reactor is managed properly, after a while an equilibrium can be established where the isotopic composition of the exit stream ceases to change. In that situation the reactor reactivity is in equilibrium, control rods are not needed (only on-off rods that do not waste neutrons), and no neutrons are wasted by absorption in the control rods. Using liquid fuel in this way instead of solid fuel, it is practical to boost the neutron economy by 4%.

The third possible boost to the neutron economy, which is the subject of this invention, is to provide high pressure (HP) graphite capable of reducing neutron loss to graphite of about 30% in a heterogeneous graphite-moderated power reactor. A power reactor using HP graphite can burn natural uranium as fuel and generate about as much energy from mined natural uranium as current light water reactors (LWRs) can generate burning enriched uranium. Other benefits of power reactors using HP graphite include the capability of potentially using as fuel all waste or spent fuel from today's LWRs without separations or reprocessing, while generating about as much energy as the LWR generated in producing its waste.

### SUMMARY OF THE INVENTION

Objects, advantages and novel features, and further scope of applicability of the present invention will be set forth in part in the detailed description to follow, and in part will become apparent to those skilled in the art upon examination of the following, or may be learned by practice of the invention.

Embodiments of the invention include a method of enhancing power reactor performance comprising providing for a power reactor a graphite moderator having a neutron diffusion coefficient higher than Acheson graphite.

Additionally included are such methods, wherein the graphite moderator has a neutron diffusion coefficient of higher than about 0.9 cm. Acceptable graphite moderators can, for example, be manufactured under pressure during graphitization.

The graphite moderator can comprise a crystalline structure more distorted than Acheson graphite and/or be capable of losing fewer neutrons by absorption in graphite than Acheson graphite.

Methods of the invention also include a graphite moderator capable of about 25% to 30% less neutron absorption in graphite than Acheson graphite.

Power reactors comprising a graphite moderator having a neutron diffusion coefficient of higher than about 0.9 cm are also included within the scope of this invention.

Such power reactors can be capable of using natural uranium as fuel and providing 25% less neutron absorption in graphite than Acheson graphite and/or capable of operating without enrichment or reprocessing of fuel.

Systems for generating power are also included as embodiments of the invention and can comprise a power reactor, such as a fission reactor, capable of producing heat energy, a fuel source, a graphite moderator manufactured under pressure during graphitization, and a generator for converting the energy from the reactor into mechanical or electrical power.

Graphite moderators in such systems are capable of having a neutron diffusion coefficient of higher than about 0.9 cm.

Systems according to embodiments of the invention can further include systems capable of using natural uranium as fuel and wherein the graphite moderator is capable of losing fewer neutrons by absorption in graphite than Acheson graphite.

Even further, the inventive systems can be capable of providing 25% less neutron absorption in graphite than Acheson graphite.

Methods of generating energy, for example, mechanical, electrical, or heat energy, are also included within the scope of the invention. For example, a method of generating electricity comprising: initiating a fission reaction of a fuel source in a power reactor, wherein the power reactor comprises a graphite moderator having a neutron diffusion coefficient of higher than about 0.9 cm, to generate heat is within the scope of the invention. Heat generated from such a reaction can be converted to steam, which can be used to power a generator for providing mechanical or electrical power. Heat generated from the reaction can also be harnessed for practical use.

The systems, devices, and methods of the invention can be compatible with uranium fuel sources, such as natural, enriched, and/or reprocessed uranium.

Likewise, the systems, devices, and methods of the invention can also be compatible with fuel sources including uranium that is not enriched.

### BRIEF DESCRIPTION OF THE DRAWINGS

FIG. 1 graphically illustrates the inelastic scattering of neutrons in perfect crystalline graphite, e.g., Acheson graphite, at various temperatures and energy levels of incoming neutrons compared with that at room temperature of graphite manufactured to produce a distorted crystalline structure, e.g., HP graphite.

FIG. 2 is a flowchart describing the Acheson process of manufacturing graphite without using pressure during the graphitization phase.

FIG. 3 is a schematic diagram showing the orientation of the carbon logs and coke of in an electric furnace employed during the Acheson manufacturing process.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

Embodiments of the present invention comprise providing artificial graphite manufactured under high pressure (HP) during the graphitization process to cause a larger neutron diffusion coefficient than graphite not produced under pressure.

Accordingly, the HP graphite therefore enables the elimination of the enormous proliferation burden of nuclear energy by obviating both enrichment and reprocessing. The costs of nuclear energy are also likely to be reduced by eliminating the costs for both enrichment and reprocessing. Because all of the waste or spent fuel from today's LWRs can be used as fuel, there is no near-term need for a geologic waste storage for the “once-through” choice of fuel cycle. Because there is no need for reprocessing to enable reuse of LWR spent fuel in LWRs or more advanced reactors, there is no near term need for a geologic repository for the waste stream from reprocessing. The present graphite discovery therefore should reduce the cost of nuclear power and resolve the three other major impediments to the widespread deployment of nuclear power: (1) proliferation concerns, (2) the need for a near-term geologic storage facility, and (3) the perceived dangers of reprocessing plants and the fast spectrum reactors that are required for closing today's fuel cycle by reprocessing.

Additionally, it is possible for nuclear power to be considered a viable alternative to oil and natural gas as an energy source. The answer lies in increasing the efficiency of traditional graphite-moderated nuclear power reactors.

Nuclear reactors operate by inducing fission in a fuel source, such as ²³⁵U. Fission causes neutrons to be emitted and at high speeds. ²³⁵U undergoes fission more readily with slow (thermal) neutrons, so a moderator is used to slow the neutrons down. One common moderator in power reactors, for example, is graphite. Moderators, however, also have the tendency to absorb neutrons making fewer neutrons available and decreasing the overall neutron economy of the reactor. Thus, avoiding loss of neutrons is a key element of increasing reactor efficiency.

One way to decrease absorption of the neutrons in the graphite-based moderator is to use a highly purified form of graphite, in particular, graphite with a low amount of boron—a known neutron absorber. The inventor has found another way to increase neutron economy, by employing graphite having an increased neutron diffusion coefficient as the graphite-type moderator.

The neutron diffusion coefficient in graphite may be increased by reducing the microcrystal diffraction scattering and increasing the non-diffractive (inelastic) scattering. The increase arises because the diffraction scattering is more in the backward direction than the non-diffractive scattering. Less back scattering means more forward scattering, and this means a shorter path for neutrons to move from one point to another and therefore less opportunity for neutrons to be absorbed in graphite.

The diffraction scattering is associated with an ordered microcrystal structure of graphite. If the order disappears or decreases, the diffraction scattering disappears or decreases, the diffusion coefficient becomes larger, and the absorption of neutrons in graphite becomes smaller.

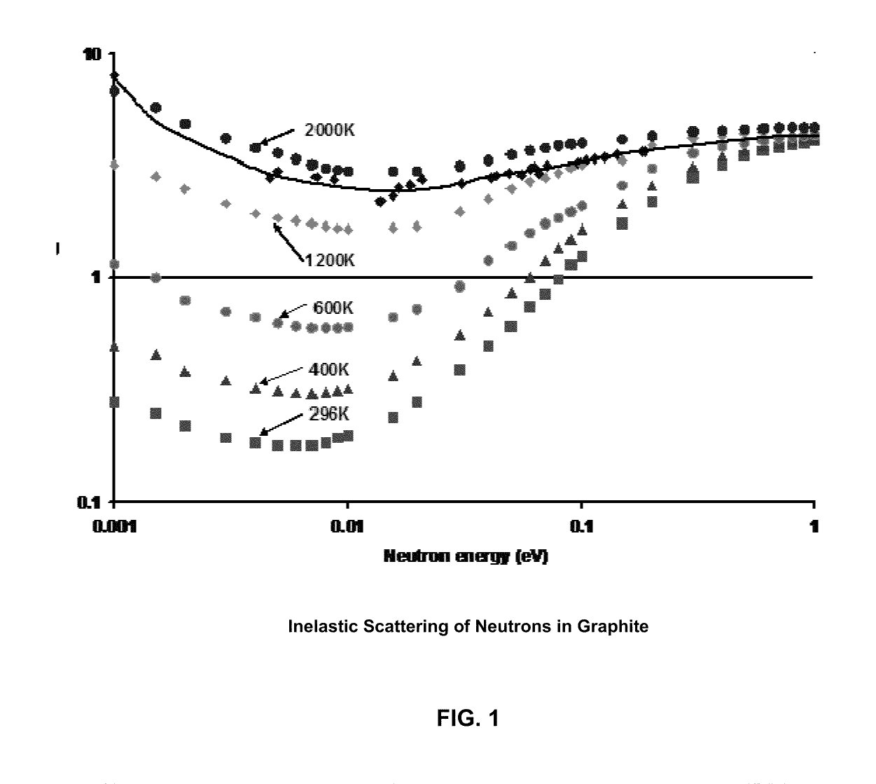

At least two means lead to less microcrystalline order. If the graphite is heated, the atoms vibrate with larger amplitude and the atoms spend less time at their ordered position in the crystal structure. The degree of departure of atoms from their perfect crystal locations can be calculated for different graphite temperatures to good accuracy and the diffraction and non-diffraction scattering also can be calculated accurately as shown in FIG. 1.

The inventor performed measurements at the Triangle University Nuclear Laboratory at Duke University using an 8-ft diameter and 8-ft high tank of graphite and found that the diffusion coefficient in the HP graphite was higher than that of the earlier graphite produced by the Acheson process and that the boron content was lower even than “reactor-grade” graphite produced by the Acheson process. Boron is an excellent absorber of neutrons with negative benefit to the reactor neutron economy and it is best to keep boron at the lowest concentrations possible in graphite.

As shown in FIG. 1, the inelastic scattering cross section in barns on the ordinate is shown plotted against the energy of an incoming neutron measured in electron volts. At 296 K near room temperature, the cross section is only 0.2 barns at 0.01 eV. When the crystal is heated causing the atoms to vibrate with greater amplitude, the inelastic scattering increases so that by the time the temperature reaches 1200 K, the cross section has increased by a factor of 10 to about 2.0 barns. Measurements of inelastic scattering by the means described in Measurements of Thermal Neutron Diffraction and Inelastic Scattering in Reactor Grade Graphite. Nuclear Science and Engineering 159, 182-198 (2008), which is hereby incorporated by reference in its entirety, could be used to show that graphite manufactured by means other than that described here would exhibit closely similar advantageous properties.

For comparison with HP graphite, the line in FIG. 1 shows the results of measurements of inelastic scattering on room temperature graphite manufactured to produce a distorted crystalline structure. The displacement of atoms from their normal positions in perfect crystalline graphite is seen to be equivalent to the displacement that would be obtained by heating perfect crystalline graphite to 1800 K.

The diffusion coefficient D is defined by D=1/[3×number of carbon atoms per cubic centimeter×effective area of the carbon nucleus in square centimeters×{1−(cos average)}] where (cos average) is the average cosine of the scattering angle for neutrons striking carbon nuclei. For example, if the average scattering angle is 90 degrees, D is twice as large as if it were 180 degrees. If the angle is 60 degrees, D is twice as large as for 90 degrees. Zero degrees would be the same as no collisions at all and in that case D is infinite.

If the probability of neutron absorption in graphite is known, one can measure D by pulsing a large graphite assembly with neutrons and measuring the die-away time of the neutrons. The neutrons die away rate is influenced by the probability that the neutrons will be absorbed in a collision with a graphite nucleus, by the distance the neutrons have to go between collisions, which is proportional to D, and by the speed of the neutrons. The Diffusion Coefficient can also be measured when the absorption in graphite is not known, which is typically the case, as was performed for the first time and published in Reducing Parasitic Thermal Neutron Absorption in Graphite Reactors by 30%, Nuclear Science and Engineering, 161, 68-77 (2009), which is hereby incorporated by reference in its entirety. This paper provides measurements for D by combining two different experiments on the same assembly. If the absorption is known, only one experiment is used to find D. If, however, absorption is not known, then both experiments are used to find D.

Earlier reactors used graphite produced by some version of the Acheson process. Acheson graphite has been measured to have a Diffusion Coefficient value of close to about 0.85±0.013 cm, with the range among different measurement being about three times the uncertainty, or from about 0.8 cm to about 0.9 cm. The inventor has found, however, that graphite manufactured to produce a distorted crystalline structure, by using a variation of the Acheson process, produces graphite with an enhanced Diffusion Coefficient of about 1.05±0.03 cm. In power reactors, the use of graphite having an enhanced Diffusion Coefficient will absorb 25% less neutrons than Acheson graphite, thereby improving reactor efficiency by 25%.

Measurements were also undertaken at the LANSCE facility at the Los Alamos National Laboratory to understand the difference between the graphite studied and the Acheson graphite. The HP graphite was found to exhibit a much less perfect crystal structure than Acheson graphite that enhanced the ratio of inelastic to diffraction scattering. The reason was that the HP graphite had been manufactured in the graphitization process at about 3000° C. under high pressure whereas the Acheson graphite was manufactured without the pressure applied. The HP graphite crystalline structure was still highly evident but the graphite microcrystals were twisted, bent, stretched, compressed, and otherwise distorted, as the pressure forced the crystallites to fit together. Diffraction scattering of neutrons was therefore suppressed as diffraction scattering requires a nearly perfect ordering of the atoms in the crystal. Diffraction scatters neutrons at larger angles than inelastic scattering with the net result that the neutrons were scattered in a more forward direction than expected causing a larger neutron diffusion coefficient. These measurements are also published in the article, Measurements of Thermal Neutron Diffraction and Inelastic Scattering in Reactor Grade Graphite. Nuclear Science and Engineering 159, 182-198 (2008).

This measurement set also showed that a mistaken crystal model is used for calculation of the diffusion of neutrons through graphite using the world standard code MCNP. The MCNP model assumes a perfect crystal structure whereas these results showed that both the high pressure (HP) and the Acheson graphite exhibited crystal structure far from perfect. The increase in diffusion coefficient and the reduction in boron content found to be present in the HP graphite together enhanced the neutron economy by another 4% over Acheson graphite.

A description of a manufacturing process for producing the graphite with enhanced inelastic scattering begins by listing the steps in the manufacturing process for normal manufactured graphite (e.g., Acheson graphite) that does not show the enhancement.

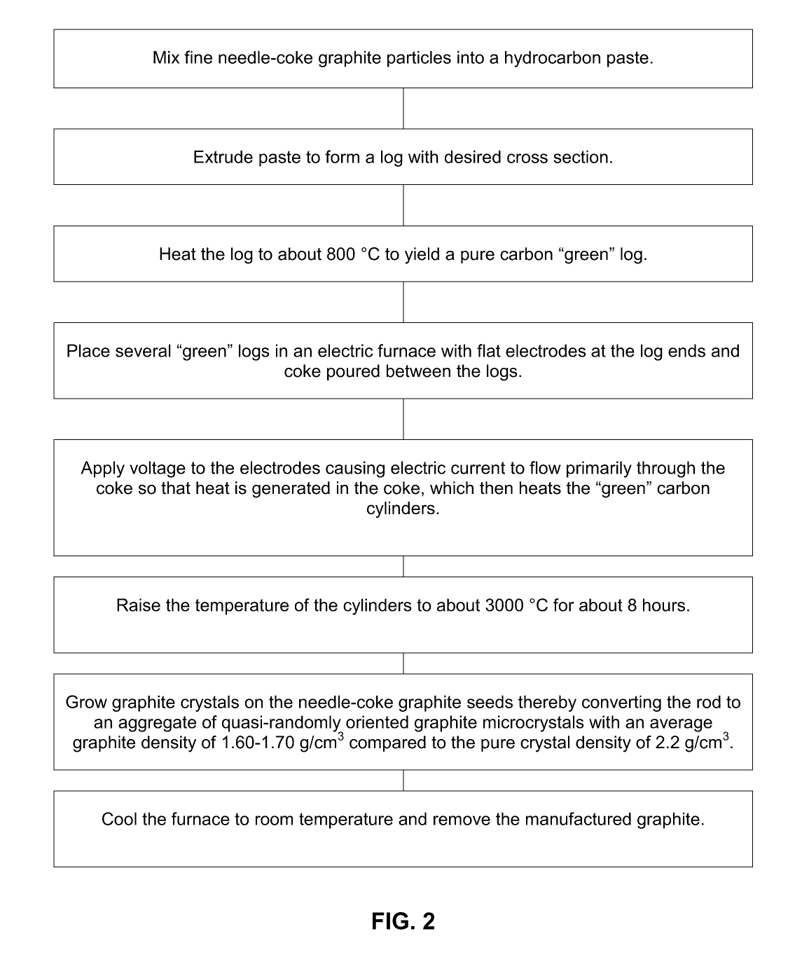

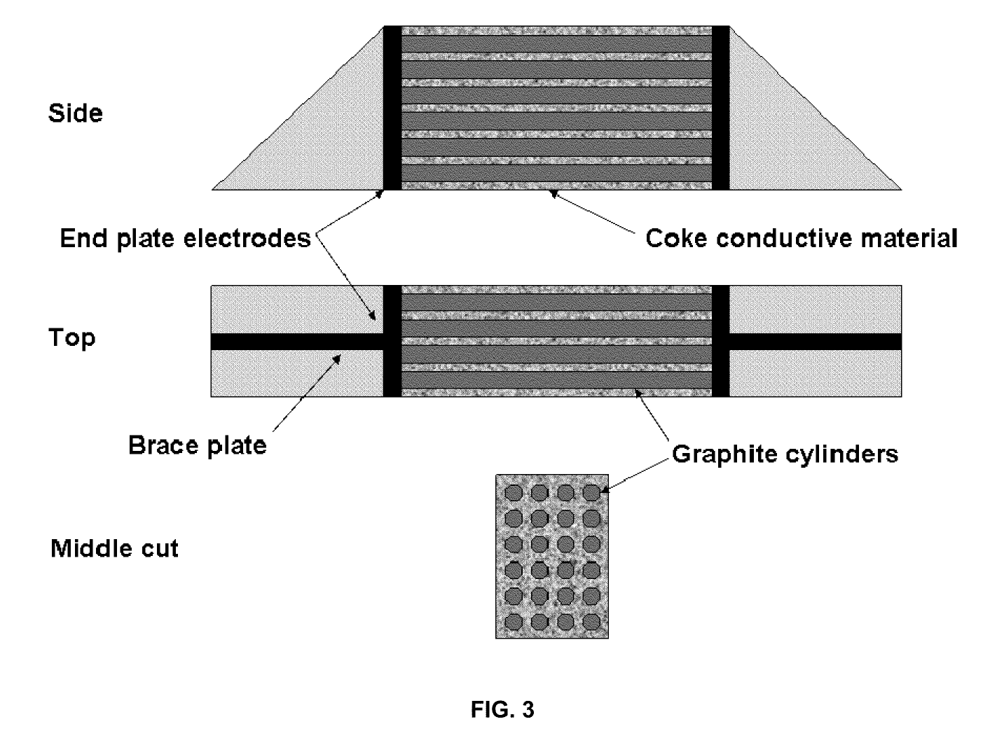

The Acheson manufacturing process is generally described in the flowchart provided in FIG. 2 and the schematic diagram provided in FIG. 3. The Acheson manufacturing process generally entails:
1. Mixing fine needle-coke graphite particles into a hydrocarbon paste that might vary from sugar to the heavy remnant byproduct from petroleum refining.
2. The paste is then extruded to form a log of cross section determined by the shape of the diffusion but perhaps circular with 24-inch diameter and an arbitrary length but perhaps 16 ft.
3. This log is then heated to about 800° C. to drive out all of the hydrogen constituents except carbon yielding a pure carbon log with the resulting log being referred to as “green.”
4. Several of these green logs or cylinders are placed in an electric furnace with flat electrodes at the ends and coke poured between them so as to separate the logs from each other as shown in FIG. 3.
5. Voltage is applied to the electrodes causing electric current to flow primarily through the coke so that heat is generated in the coke, which then heats the green carbon cylinders.
6. The temperature of the cylinders is raised by this means to 3000° C. and held at this level for a period of about 8 hours.
7. The graphite crystal structure grows on the many needle-coke graphite seeds until the graphite rod is converted to an aggregate of quasi-randomly oriented graphite microcrystals with an average graphite density of 1.60-1.70 g/cm³ compared to the pure crystal density of 2.2 g/cm³.
8. The furnace is then allowed to cool naturally to room temperature before removal of the manufactured graphite.

The graphite manufactured by this process, referred to as the Acheson process, is not an array of perfect microcrystals because some distortion is introduced as the crystals grow into contact with one another.

The distortion of the crystals may be significantly enhanced by a modified process that puts the carbon cylinders under pressure, which is described next, to produce the HP graphite with enhanced Diffusion Coefficient.

Differences in the manufacturing process include placing the cylinders in the furnace without coke poured between them to separate and heat the cylinders. The cylinders have previously been cut to precisely the same length and with flat right-angle surfaces at the ends so that the end surfaces may rest in firm contact with the flat electrode surface, such as two robust flat steel electrodes. High pressure is then placed on the carbon pieces by squeezing them with force applied by the heavy flat electrodes. The amount of pressure can be any amount of pressure sufficient for introducing to the carbon a more distorted crystalline form. As much pressure as possible should be applied without crushing the graphite and/or breaking the carbon logs. It is recommended to monitor the amount of pressure being applied in case adjustments in increasing or decreasing the pressure are needed during the process. An exemplary amount of pressure that can be used is a pressure in the range of about 100 psi. Further, for example, it is possible to use heavy petroleum products containing carbon leftover from refinery operations as a starting material.

The electric current flows through the carbon cylinders (rather than through coke, which is absent) and the heat is generated in the cylinders themselves, to heat the cylinders to about 3000° C. The temperature and pressure conditions should be applied for a time sufficient to obtain graphite with a crystalline structure different from that obtained by the Acheson process. For example, these conditions can be maintained for a period of about 8 hours. As the temperature rises and the crystalline structure begins to form under pressure, the distortion of the microcrystals as they grow into contact with one another is significantly enhanced over that present in graphite produced without pressure using the Acheson process. The microcrystals are thus much less perfect than the Acheson graphite owing to the distortions imposed by the pressure. Measurements of Thermal Neutron Diffraction and Inelastic Scattering in Reactor Grade Graphite. Nuclear Science and Engineering 159, 182-198 (2008). Manufacturing the graphite under pressure increases the neutron diffusion coefficient over that of Acheson graphite by about 25%, resulting in an about 25% reduction in neutron absorption for neutron diffusing through graphite.

Realizing the 25% reduction in neutron loss arising from an increase by 25% in the diffusion coefficient requires attention to the design of the graphite reactor core. There are well known benefits to graphite reactor performance arising from a heterogeneous array of nuclear fuel in the graphite moderator, which were included in the first reactor demonstration led by E. Fermi at Stagg Field at the University of Chicago. The working definition of heterogeneity in this context is a geometrical arrangement between fuel and graphite such that a thermal neutron scatters many times in graphite before it enters the reactor fuel and that the likelihood that the neutron is absorbed in the fuel, once it enters, is rather high and in the range of 50%.

Graphite reactors that are not designed to be heterogeneous in accordance with the above definition will be inferior in neutron economy to heterogeneous reactors. Of course, reactors might be designed for purposes other than optimizing the neutron economy, such as burning away the excess weapons plutonium stockpiles in the U.S. and Russia. Heterogeneous reactors designed using graphite with a smaller diffusion coefficient will be inferior to designs using graphite with a larger diffusion coefficient. The advantage from a larger diffusion coefficient would be manifested in terms of reducing the amount of fuel, reducing or even avoiding the need for uranium fuel enrichment, reducing the size of the accelerator or other neutron source needed to drive a subcritical reactor, or enabling Light Water Reactor (LWR) spent reactor fuel contaminated with fission products, higher actinides, and so on, to be used as heterogeneous graphite reactor fuel.

Altogether the neutron economy may be improved by 5% using a practical accelerator, by 4% using the patented continuously flow concept, and by another 4% using the HP graphite for a total reactivity enhancement of 13%. To the reactor designer, this is an enormous gain being equivalent to increasing the number of neutrons emitted from fission from 2.45 for ²³⁵U to 2.77, which is the same as for ²³⁹Pu.

As a consequence it is practical to build and operate a reactor using this HP graphite, using an accelerator supplying 1% of the neutrons (k_{eff}=0.99) and using the patented continuous flow concept that can burn natural uranium as fuel and generate about as much energy from mined natural uranium as current light water reactors can generate burning enriched uranium. In addition, the reactor using HP graphite can be built to use all of the waste or spent fuel from today's light water reactors (LWRs) without separations or reprocessing as fuel, and generate about as much energy as the LWR generated in producing its waste. By all the waste, what is meant is that all of the waste inside the LWR spent fuel cladding including solid fission product, all the ²³⁸U, all of the fissile isotopes, and any higher actinides.

Today's accelerator technology also would enable the practical cycling again of the effluent resulting from the first pass of LWR waste through its system at k_{eff}=0.99. With a five times more powerful accelerator and k_{eff}=0.95, the subcritical reactor would generate as much power again as the LWR did. It is further estimated that the efficiency of the accelerator for conversion of electric power to neutrons can be doubled from today's technology before reaching its limits so that another recycle with the same power production at K_{eff}=0.90 is practical.

If today's LWRs continue to operate for another 40 years beyond their present 40-year lifetime and a fleet of these new systems is deployed to burn the waste twice as fast as it is generated, the total nuclear electric power in the United States would be tripled (to 60%) and it would take 40 years to burn the waste from the LWRs at k_{eff}=0.99. Two more cycles at k_{eff}=0.95 and 0.90 would require another 80 years. That is a total of 120 years before accelerators have run their course.

It is easy to show that long before fusion power becomes an electric power source economically competitive with fission, it will be a much cheaper source of neutrons than accelerators. Several more cycles would be possible then at k_{eff} less than 0.90 before the fuel is finally spent. If the final spent fuel after many cycles is disposed of in geologic storage, the time for that will be perhaps three centuries away. Because nothing is thrown away in the recycling, the long-lived fission products and the higher actinides are being concurrently transmuted from radioactive to stable species throughout the 300-year period. Owing to this concurrent transmutation, the long-lived component of the waste 300 years hence might be little more than that in the original spent fuel from the LWRs. This recycling therefore does not ultimately leave an increasing burden of radioactivity for future generations beyond that from just once through an LWR.

The HP graphite therefore enables the elimination of the enormous proliferation burden of nuclear energy by obviating both enrichment and reprocessing. The costs of nuclear energy are also likely to be reduced by eliminating the costs for both enrichment and reprocessing. Because all of the waste or spent fuel from today's LWRs can be used as fuel, there is no near-term need for a geologic waste storage for the “once-through” choice of fuel cycle. Because there is no need for reprocessing to enable reuse of LWR spent fuel in LWRs or more advanced reactors, there is no near term need for a geologic repository for waste stream from reprocessing either.

The present graphite discovery therefore should reduce the cost of nuclear power and resolve the three other major impediments to the widespread deployment of nuclear power: (1) proliferation concerns, (2) the need for a near-term geologic storage facility, and (3) the perceived dangers of reprocessing plants and the associated fast spectrum reactors that are required for closing today's fuel cycle.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A method of enhancing power reactor performance comprising providing for a power reactor a graphite moderator having a neutron diffusion coefficient higher than Acheson graphite.

2. The method according to claim 1, wherein the graphite moderator has a neutron diffusion coefficient of higher than about 0.9 cm.

3. The method according to claim 1, wherein the graphite moderator is manufactured under pressure during graphitization.

4. The method according to claim 1, wherein the graphite moderator comprises a crystalline structure more distorted than Acheson graphite.

5. The method according to claim 1, wherein the graphite moderator is capable of losing fewer neutrons by absorption in graphite than Acheson graphite.

6. The method according to claim 5, wherein the graphite moderator is capable of 25% less neutron absorption in graphite than Acheson graphite.

7. A power reactor comprising a graphite moderator having a neutron diffusion coefficient of higher than about 0.9 cm.

8. The power reactor according to claim 7 capable of using natural uranium as fuel and providing 25% less neutron absorption in graphite than Acheson graphite.

9. The power reactor according to claim 8 capable of operating without enrichment or reprocessing of fuel.

10. A system for generating power comprising a fission reactor capable of producing heat energy, a fuel source, a graphite moderator manufactured under pressure during graphitization, and a generator for converting the energy from the reactor into electrical power.

11. The system according to claim 10, wherein the graphite moderator has a neutron diffusion coefficient of higher than about 0.9 cm.

12. The system according to claim 11 capable of using natural uranium as fuel and wherein the graphite moderator is capable of losing less neutrons by absorption in graphite than Acheson graphite.

13. The system according to claim 12, wherein the graphite moderator is capable of providing 25% less neutron absorption in graphite than Acheson graphite.

14. A method of generating electricity comprising:
initiating a fission reaction of a fuel source in a power reactor, wherein the power reactor comprises a graphite moderator having a neutron diffusion coefficient of higher than about 0.9 cm, to generate heat;
converting the heat to steam; and
providing the steam as power to a generator capable of generating electricity.

15. The method according to claim 14, wherein the fuel source is uranium.

16. The method according to claim 15, wherein the uranium is not enriched.
